(19) United States
(12) Patent Application Publication
(10) Pub. No.: US 2025/0165592 A1
(43) Pub. Date: May 22, 2025

(54) METHOD FOR REAL-TIME DETECTION AND BLOCKING OF RANSOMWARE BASED ON BEHAVIOR INFORMATION ANALYSIS

(71) Applicant: WINS Co., Ltd., Seongnam-si (KR)

(72) Inventors: Seungnyoung HEO, Suwon-si (KR); Ju Seob KIM, Yongin-si (KR)

(73) Assignee: WINS Co., Ltd., Seongnam-si (KR)

(21) Appl. No.: 18/762,078

(22) Filed: Jul. 2, 2024

(30) Foreign Application Priority Data
Nov. 16, 2023 (KR) 10-2023-0159208

(51) Int. Cl. G06F 21/55

(52) U.S. Cl. CPC G06F 21/554; G06F 2221/034

(57) ABSTRACT

Provided is a ransomware detection method of an electronic device, including: generating monitoring information including information on a first file in response to an open of a first file; setting any one of a first flag corresponding to file generation and a second flag corresponding to file deletion in the monitoring information in response to a first behavior associated with the first file; setting a flag different from the flag set in the monitoring information in response to the first behavior among the first and second flags in the monitoring information in response to a second behavior that is a subsequent behavior of the first behavior; and detecting a process associated with the ransomware by performing analysis based on the first and second flags set in the monitoring information.

### CROSS-REFERENCE TO RELATED APPLICATIONS

This application claims benefit of priority to Korean Patent Application No. 10-2023-0159208 filed Nov. 16, 2023, the entire content of which is incorporated herein by reference.

### TECHNICAL FIELD

The present disclosure relates to a method for real-time detection and blocking of ransomware based on behavior information analysis, and an electronic device performing the same.

### BACKGROUND

Ransomware is malicious software that encrypts computer data and then requests money from a user in exchange for data recovery. The ransomware causes a lot of damage around the world, and especially, is intruding into important infrastructure, such as public institutions and businesses, to cause huge losses. The ransomware encrypts or deletes files on the infected computer and displays messages demanding payment in virtual currency such as Bitcoin for recovery. The ransomware uses anonymous communication systems to communicate with command and control servers, collect information from the infected computers, or download additional malicious code.

Examples of the conventional technologies used to detect such ransomware include a decoy-based detection method and a method for determining whether the same generated file is encrypted. The former is a method in which a decoy file is accessed first when accessing a file, and then, if it is deleted and encrypted, the process is determined as ransomware. The latter is a method for comparing the existing file and the generated file and confirming based on a header whether structures of the two files is the same but the generated file is encrypted to determine whether the process that has performed the operation is ransomware.

The former detection method has the problem of being neutralized when the ransomware bypasses the decoy, and the latter detection method has the problem of being neutralized because the detection method may not compare the generated file with the existing file when the ransomware deletes the file first. Therefore, there is a need for a ransomware detection method that can solve this problem.

### SUMMARY

The disclosed embodiments provide an electronic device and a ransomware detection method. Specifically, the present disclosure is to detect ransomware in real time by analyzing behavior information, regardless of the order of storing and deleting files.

The technical problems to be achieved by the embodiments of the present disclosure are not limited to the technical problems as described above, and other technical problems may be inferred from the following embodiments.

The present disclosure provides a ransomware detection method of an electronic device, including: generating monitoring information including information on a first file in response to an open of a first file; setting any one of a first flag corresponding to file generation and a second flag corresponding to file deletion in the monitoring information in response to a first behavior associated with the first file; setting a flag different from the flag set in the monitoring information in response to the first behavior among the first and second flags in the monitoring information in response to a second behavior that is a subsequent behavior of the first behavior; and detecting a process associated with the ransomware by performing analysis based on the first and second flags set in the monitoring information.

The setting of the flag different from the flag set in response to the first behavior among the first or second flag in the monitoring information may include: detecting the second behavior as the subsequent behavior of the first behavior, associated with the first file; confirming the monitoring information corresponding to the first file in the list, and the detecting of the process associated with the ransomware may include detecting at least some of the at least one first process, which opens the first file and performs the first and second behaviors, as a process associated with the ransomware by confirming that the first flag and the second flag are set in the monitoring information.

The detecting of the at least some of the at least one process as the process associated with the ransomware may include: analyzing a call structure of the first process that opens the first file and performs the first and second behaviors based on a process call tree; detecting a second process that calls at least some of the first process based on the call structure; and further detecting at least some of the second process as the process associated with the ransomware.

The further detecting of the at least some of the second process as the process associated with the ransomware may include classifying at least some of the first and second processes into a system process and a suspicious process, and detecting at least some of the suspicious processes as the process associated with the ransomware.

The system process may include at least a portion of a scheduler and a shell.

The open of the first file of the first process and the first and second behaviors may be detected by analyzing the call to the corresponding command at a kernel stage, and the monitoring information may further include information on the first file confirmed by analyzing the call.

The ransomware detection method may further include blocking, at the kernel stage, the command called from the kernel level by at least some of the first processes.

The first process may include a 1-1th process associated with the open of the first file, a 1-2th process associated with the first behavior, and a 1-3th process associated with the second behavior, at least some of which are different from each other.

The first behavior may correspond to the file generation of a second file associated with the first file, the second behavior may correspond to the file deletion of the first file, and the first flag may be set in monitoring information in response to the first behavior.

The ransomware detection method may further include performing the file deletion of the first file according to the second behavior and the deletion of the second file generated according to the first behavior.

The first behavior may correspond to the file deletion of the first file, the second behavior may correspond to the file generation of the second file associated with the first file, the second flag may be set in the monitoring information in response to the first behavior, and the monitoring information and backup information corresponding to the first file may be stored in association with each other.

The ransomware detection method may further include restoring the first file deleted according to the first behavior based on the backup information and deleting the second file generated according to the second behavior.

The second file generated by any one of the first and second behaviors corresponding to the file storage may be confirmed as at least one of a file generated in a directory corresponding to the first file or a file generated with a similarity to the first file greater than or equal to a threshold value.

The detecting of the process associated with the ransomware may include performing the analysis of the process further based on information on a time difference between the first and second behaviors detected.

The detecting of the process associated with the ransomware may include performing the analysis of the process further based on information on the number of times per hour that the a combination of the first and second behaviors associated with each file included in a specific range of directories including the first file is detected.

The present disclosure also provides an electronic device for detecting ransomware, including: a memory that stores an instruction; and a processor connected to the memory and set to generate monitoring information including information on a first file in response to an open of a first file, set any one of a first flag corresponding to file deletion and a second flag corresponding to file generation in the monitoring information in response to a first behavior associated with the first file, set a flag different from the flag set in the monitoring information in response to the first behavior among the first and second flags in the monitoring information in response to a second behavior that is a subsequent behavior of the first behavior, and detect a process associated with the ransomware by performing analysis based on the first and second flags set in the monitoring information.

There may be provided a computer-readable non-transitory recording medium in which a program for a computer to execute the method of the above-described ransomware detection method is recorded.

Detailed contents of other embodiments are described in a detailed description and are illustrated in the accompanying drawings.

According to the proposed embodiments, one or more of the following effects can be expected.

According to the embodiment of the present specification, when the file is deleted or stored regardless of the order after opening the document file, it is possible to detect the process as ransomware in real time by analyzing the behavior information analysis.

In addition, according to the embodiment of the present specification, it is possible to detect the ransomware most quickly as the detection and blocking operates in the kernel mode.

In addition, according to the embodiment of the present specification, it is possible to detect the activity of the ransomware through the Windows built-in processes by performing the monitoring in the kernel mode.

Effects of the present disclosure are not limited to the above-mentioned effects, and other effects that are not mentioned will be clearly understood by those skilled in the art from the description of the claims.

### BRIEF DESCRIPTION OF THE DRAWINGS

FIG. 1 is a diagram illustrating an electronic device for detecting ransomware according to one embodiment.

FIG. 2 is a flowchart for describing a ransomware detection method according to an embodiment.

FIG. 3 is a flowchart for monitoring an open of a document file according to an embodiment.

FIG. 4 is a flowchart for monitoring a generation of the document file according to one embodiment.

FIG. 5 is a flowchart for monitoring deletion of the document file according to one embodiment.

FIG. 6 is a flowchart in which ransomware is detected when a file is stored and then deleted, according to an embodiment.

FIG. 7 is a flowchart in which the ransomware is detected when a file is deleted and then stored, according to an embodiment.

FIG. 8 is a block diagram of an electronic device according to one embodiment.

### DETAILED DESCRIPTION

General terms that are currently widely used are selected as terms used in embodiments in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

Throughout the specification, unless otherwise specified, “including” any component means that other components may be further included rather than excluding other components.

The expression “at least one of a, b, and c” described throughout the specification may include “a alone,” “b alone,” “c alone,” “a and b,” “a and c,” “b and c,” or “all of a, b, and c”.

A “terminal” described below may be implemented as a computer or a portable terminal that may access a server or other terminals through a network. Here, computers may include, for example, a notebook, a desktop, a laptop, and the like, which are equipped with a web browser, and portable terminals are wireless communication devices that ensure portability and mobility, and may include, for example, International Mobile Telecommunications (IMT), code division multiple access (CDMA), W-code division multiple access (W-CDMA), and Long Term Evolution (LTE) terminals, and all kinds of handheld-based wireless communication devices, such as a smartphone and a tablet PC.

Hereinafter, embodiments of the disclosure will be described in detail with reference to the accompanying drawings so that those skilled in the art to which the disclosure pertains may easily practice the disclosure. However, the present disclosure may be implemented in various different forms, and is not limited to the embodiments described herein.

Hereinafter, embodiments of the present disclosure will be described in detail with reference to the drawings.

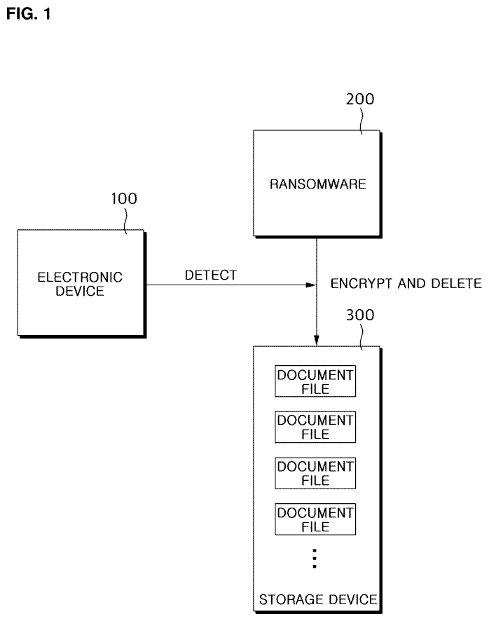

FIG. 1 is a diagram illustrating an electronic device for detecting ransomware according to one embodiment.

Referring to FIG. 1, an electronic device 100 may be used to detect an operation of ransomware 200 to encrypt and delete document files stored in a storage device 300. Here, according to one embodiment, the ransomware 200 attacks a system including the electronic device 100, and the electronic device 100 may be a component in charge of calculations inside the system to defend against the ransomware 200. According to another embodiment, the electronic device 100 is an electronic device separate from the system attacked by the ransomware 200, and may be used to detect encryption and deletion of document files in the storage device 300 by ransomware 200 from the outside in order to protect the system. However, the contents described above are only an example, and regardless of the relationship between an attack target of the ransomware 200 and the electronic device 100, it is considered that detecting the attack of the ransomware 200 using the electronic device 100 according to the method described below falls within the scope of the present disclosure.

Meanwhile, FIG. 1 illustrates only the components related to the present embodiment of the electronic device 100, the ransomware 200 attacking the electronic device 100, and the storage device 300. Accordingly, it can be understood by those of ordinary skill in the art related to the present embodiment that other general-purpose components may be further included in addition to the components illustrated in FIG. 1.

The electronic device 100 is a device that configures and provides various types of information. The electronic device 100 may provide configured information in the form of a web page, an application screen, or the like, or may provide the configured information as information in the form that may be displayed as the web page, the application screen, or the like, on a terminal receiving the configured information. Examples of the electronic device 100 include a smartphone or a PC, but are not limited thereto.

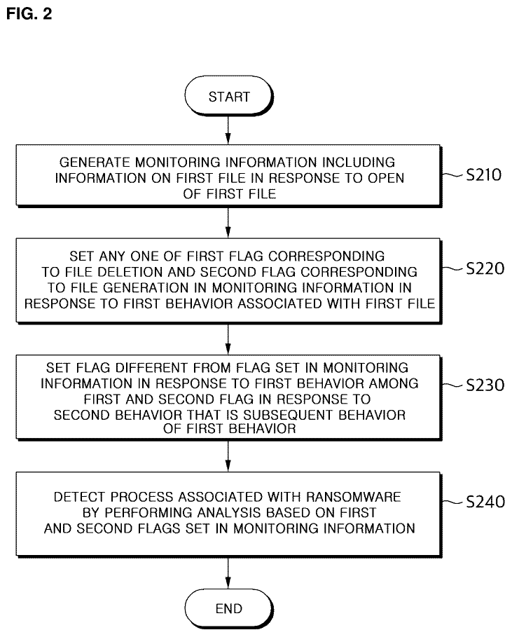

Describing briefly, the ransomware detection method to be described below relates to a method capable of detecting and blocking ransomware in real time by analyzing behavior information. Here, the behavior information may include information related to file open, file generation, and file deletion, according to one embodiment. As will be described below, the electronic device 100 may manage information on detecting file open, file generation, and file deletion, respectively, on a list related to behavior information, and analyze each combination based on the list related to the behavior information managed in this way to detect in real time whether the ransomware attack has occurred. Hereinafter, it will be described with reference to FIG. 2.

FIG. 2 is a flowchart for describing a ransomware detection method according to an embodiment.

In step S210, the electronic device 100 may generate monitoring information including information on the first file in response to the open of the first file. In step S220, the electronic device 100 may set any one of a first flag corresponding to the file deletion and a second flag corresponding to the file generation in the monitoring information in response to the first behavior associated with the first file. In step S230, the electronic device 100 may set the flag different from the flag set in the monitoring information in response to the first behavior among the first and second flags in the monitoring information, in response to a second behavior that is a subsequent behavior of the first behavior. In step S240, the electronic device 100 may detect a process associated with the ransomware by performing the analysis based on the first and second flags set in the monitoring information. Here, the operations of steps S210 to S240 may be performed in real time. For example, in steps S210 to S230, the generation of the monitoring information and the setting of the first and second flags may be performed immediately in response to the detection of the file open, the file deletion, and the file generation. The analysis in step S240 may also be performed immediately in response to detecting that both the first and second flags are set in one monitoring information. Through this operation, the ransomware attack may be quickly detected in real time.

Hereinafter, each step will be described in more detail.

First, as in step S210, the electronic device 100 may detect the open of the first file and generate the monitoring information including the information on the first file in response to the detection. Here, the first file is a document file, and the open of the first file may be confirmed by detecting an open of a file having an extension of a widely known document format file. Thereafter, the electronic device 100 may generate the monitoring information including the information on the first file. Here, the monitoring information may include information on an open time, a file path, a file name, and related processes of the first file. According to one embodiment, as will be described later, the related process may include at least some of a first process that has directly performed the open operation of the first file or a second process that has called the first process. According to one embodiment, the monitoring information may also include information on the contents of the first file. According to one embodiment, the monitoring information may be stored in the list related to the open of the document file including the first file. For example, in such a list, the electronic device 100 may detect each time the document file is opened and store each monitoring information including the information on the opened document file. Hereinafter, among the plurality of monitoring information, the monitoring information corresponding to the first file will be assumed and described.

Thereafter, in step S220, the electronic device 100 may detect the first behavior associated with the first file. Here, the first behavior may correspond to the file deletion or the file generation. When the first behavior is the file generation, the electronic device 100 may set the first flag in the monitoring information. When the first behavior is the file deletion, the electronic device 100 may set the second flag in the monitoring information.

Here, the setting of the first or second flag may be in the form of inputting the first or second flag to the row corresponding to the monitoring information in the list related to the behavior information in the form of a table including rows of a specified format. For example, the setting of one of the first or second flags may be performed by setting one of the Boolean type variables corresponding to each of the first and second flags to true. In this case, as will be described later, when the second flag corresponding to the file deletion is set, the second flag and backup information of the first file may be set in association with reach other. According to one embodiment, an additional variable included in the format specified for the monitoring information may be implemented in such a way that it includes the information on the location of the backup information of the first file.

According to one embodiment, the determination of whether the first behavior is related to the first file may be slightly different depending on whether the first behavior is the file deletion or the file generation. When the first behavior is the file deletion and the target of the first behavior is the first file, it can be considered that the first behavior is associated with the first file. When the first behavior is the file generation, the location of the second file generated according to the first behavior is a directory in a certain range corresponding to the first file, or a similarity between the contents of the second file and the first file is greater than or equal to a threshold value, it may be considered that the behavior is associated with the first file. Example of the former may include a case where the generation of the second file that occurs in the directory where the first file is stored or in a directory adjacent thereto may be determined as the first behavior associated with the first file. An example of the latter may include a case where the contents are almost identical to the first file, with the similarity being greater than or equal to the threshold value, but the generation of the second file whose encryption is added is determined as the first behavior associated with the first file. All such descriptions are merely examples, and the correlation between the first file and the first behavior may be determined through other criteria, which is also considered to be included in the scope of the present disclosure.

First, step S220 when the first behavior corresponds to file generation will be described below.

According to one embodiment, the electronic device 100 may detect the generation of the second file. Thereafter, the electronic device 100 may confirm the monitoring information based on the list. That is, the electronic device 100 may confirm the corresponding monitoring information on the list based on the directory in which the second file is stored or the contents of the second file. For example, when the second file is stored in A\B\C directories, the monitoring information on the file whose storage path is A\B\C\ may be found on the list. Alternatively, the monitoring information on a file with contents similar to that of the second file may be confirmed on the list. Through this process, the electronic device 100 may detect the generation of the second file as the first behavior associated with the first file and confirm the corresponding monitoring information on the list. Thereafter, the electronic device 100 may set the first flag in the monitoring information.

Next, step S220 when the first behavior corresponds to the file deletion will be described below.

According to one embodiment, the electronic device 100 may detect the deletion of the first file. Thereafter, the electronic device 100 may confirm the monitoring information based on the list. That is, the electronic device 100 may confirm the corresponding monitoring information on the list based on the directory in which the first file is stored or the name of the first file. Through this process, the electronic device 100 may detect the deletion of the first file as the first behavior associated with the first file and confirm the corresponding monitoring information on the list. Thereafter, the electronic device 100 may set the second flag in the monitoring information. In this case, the electronic device 100 may store the monitoring information and the backup information corresponding to the first file in association with each other. As an example, the second flag or the monitoring information may include an address on the memory of the backup information.

Thereafter, in step S230, the electronic device 100 may detect the second behavior that is a subsequent behavior of the first behavior. Here, the second behavior may be detected as the subsequent behavior of the first behavior in that it is associated with the first file. The second behavior may also correspond to the file deletion or the file generation. When the first behavior corresponds to the file generation, the second behavior may correspond to the file deletion. Conversely, when the first behavior corresponds to the file deletion, the second behavior may correspond to the file generation. Here, the correlation of the second behavior with the first file may be determined based on criteria similar to the criteria for determining the correlation with the first file of the first behavior described above. Accordingly, the electronic device 100 may set the flag opposite to the flag set according to the first behavior in the monitoring information. For example, when the first behavior corresponds to the file generation of the second file and the first flag is set in the monitoring information, the electronic device 100 may detect the second behavior as the deletion of the first file and then find the corresponding monitoring information on the list and set the second flag in the found monitoring information. Conversely, when the first behavior corresponds to the file deletion of the first file and the second flag is set in the monitoring information, the electronic device 100 may detect the second behavior as the deletion of the second file and then find the corresponding monitoring information on the list and set the first flag in the found monitoring information. Here, similar to the above-described description, the monitoring information corresponding to the second behavior as the file generation of the second file may be confirmed by finding the corresponding monitoring information on the list based on the directory in which the second file is stored or the contents of the second file.

Thereafter, in step S240, the electronic device 100 may detect the process associated with the ransomware by performing the analysis based on the first and second flags set in the monitoring information. According to one embodiment, when both the first and second flags are set in the monitoring information, the electronic device 100 may detect that at least some of the at least one first process that performs the open of the first file and the first and second behaviors is the process related to the ransomware. Here, the first process may include a 1-1th process associated with the open of the first file, a 1-2th process related to the first behavior, and a 1-3th process associated with the second behavior. In addition, at least some of the 1-1th to 1-3th processes may be different from each other.

According to one embodiment, the electronic device 100 may perform the analysis of the process based on the information on the time difference between the first and second behaviors detected, along with the first and second flags. That is, when the time difference between the first and second behaviors detected is a level that may not occur with normal user behavior, for example, 0.1 seconds or less, the first and second behaviors may be regarded as the behaviors caused by the ransomware, and at least some of the processes may be detected as being associated with the ransomware.

According to one embodiment, the electronic device 100 may perform the analysis of the process further based on the information on the number of times per hour that the combination of the first and second behaviors associated with each of the files included in the specific range of directory including the first file is detected, together with the first and second flag. In other words, in the specific range of directory including the first file, for example, the folder in which the first file is stored, when the combination of the first and second behaviors for each file, that is, the number of times per hour both the storage and deletion occur is a level that may not occur with normal user behavior, for example, more than 10 times per second, the first and second behaviors may be regarded as the behaviors caused by the ransomware, and at least some of the first process may be detected as being associated with the ransomware.

Here, additionally, the electronic device 100 may analyze the call structure of the first process based on a process call tree mapped by recording calls between the processes. The electronic device 100 may detect the second process that has called at least some of the first process based on the call structure. Thereafter, in addition to at least some of the first process, the electronic device 100 may detect at least some of the second process as the process associated with the ransomware. For example, the process A, which is the ransomware, may call the process B to open the file, the process C may call to store the file, and the process D may call to delete the file. In this case, the electronic device 100 for performing the ransomware detection method according to the present disclosure may detect processes B, C, and D as the 1-1th to 1-3th processes, respectively, and process A as the second process, and determine that at least some of processes A, B, C, and D are associated with the ransomware. Unlike this example, there may be a plurality of second processes. In addition, other processes that have called the second process, and furthermore, even a root process, which is a root of all process calls related to the file open, the file generation, and the file deletion, may be detected, and the second process of the present disclosure may be expanded to the concept including the same. That is, it may include all the related processes in any way to the behavior information, including the file open, the file deletion, and the file generation.

According to one embodiment, the electronic device 100 may classify at least some of the first and second processes into the system process and the suspicious process, and detect at least some of the suspicious process, excluding the system process, as the process related to the ransomware. Here, the system process may include at least a portion of a scheduler and a shell. The ransomware may call the file open, the file generation, or the file deletion through the system process such as the scheduler or shell fundamentally in OS. In this case, the system process itself is not associated with the ransomware, and the process calling the same may be determined to be associated with the ransomware.

According to one embodiment, the electronic device 100 may detect the open of the first file and the first and second behaviors, that is, the behavior information related to the first file, in a kernel stage. That is, the electronic device 100 can detect the open of the first file and the first and second behaviors by analyzing the call to the command in the kernel stage. Since any operation on the file system, such as the file open, the file generation, and the file deletion accesses a physical disk through the kernel, by monitoring the kernel stage, any operation may be detected without being bypassed.

As described above, after detecting at least some of the first and second processes as the processes associated with the ransomware, the electronic device 100 may restore the change in the file caused by the first and second behaviors to its original state. According to one embodiment, when the first behavior corresponds to the file generation and the second behavior corresponds to the file deletion, the electronic device 100 may delete the second file generated according to the first behavior and block the first file from being deleted. Conversely, according to one embodiment, when the first behavior corresponds to the file deletion and the second behavior corresponds to the file generation, the electronic device 100 may restore the first file deleted according to the first behavior and delete the second file generated according to the second behavior. Here, the recovery of the first file may be performed based on the backup information stored in association with the above-described second flag. In addition, according to one embodiment, at least some of the first process, and furthermore, at least some of the second process may be blocked from the kernel stage. That is, the kernel may ignore commands called by at least some of the other processes called by the first process or the second process and may not perform an operation accordingly. Of course, even in this case, the process corresponding to the system process or other processes called thereby may not be ignored by the kernel. In addition, the blocking of at least some of the processes confirmed as the ransomware may be performed immediately, that is, in real time, in response to the confirmation of the process as the ransomware.

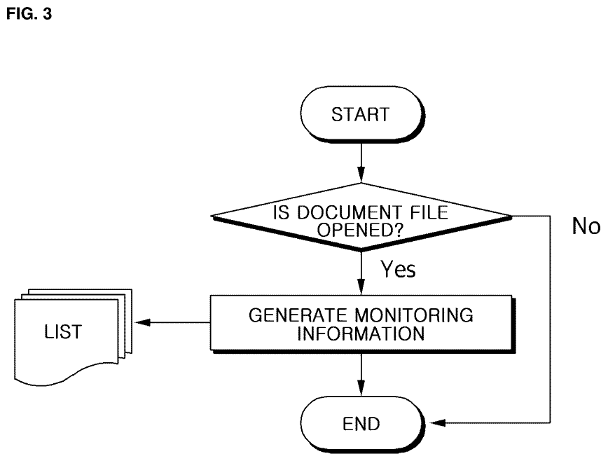

The above process may be managed by allowing independent processes related to each behavior information monitoring the file open, the file generation, and the file deletion in the kernel stage, that is, a document file open monitoring process, a document file generation monitoring process, and a document file deletion monitoring process, respectively, to manage the single list, that is, the list of the behavior information. To describe the ransomware detection method according to an embodiment of the present disclosure based on the single list, reference will be made to FIGS. 3 to 5.

FIG. 3 is a flowchart for monitoring an open of a document file according to an embodiment.

Referring to FIG. 3, a flowchart of the document file open monitoring process may be confirmed. That is, when the document file such as the first file is opened, the electronic device 100 may detect this in the kernel stage and generate the monitoring information, through the document file open monitoring process. Thereafter, it may be stored in the list.

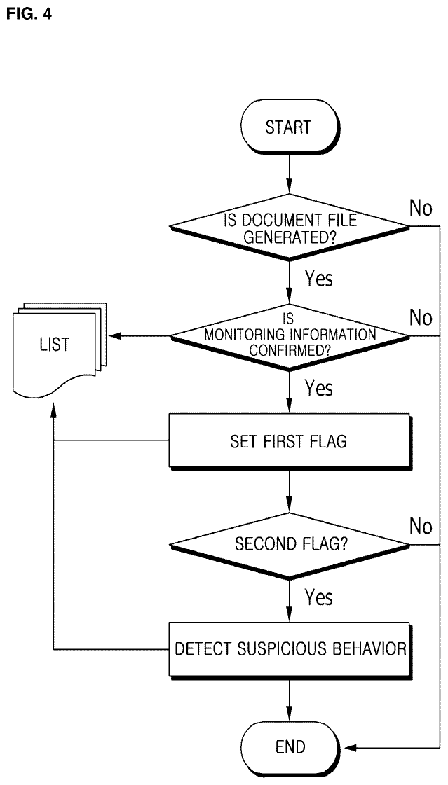

FIG. 4 is a flowchart for monitoring a creation of the document file according to one embodiment.

Referring to FIG. 4, a flowchart of the document file generation monitoring process may be confirmed. That is, when the document file such as the second file is generated, the electronic device 100 may detect this in the kernel stage and generate the corresponding monitoring information in the list, through the document file generation monitoring process. That is, based on the storage directory information of the second file or the contents information of the second file, it is possible to confirm whether the corresponding first file has previously been opened and the monitoring information has been generated, find the monitoring information, and set the first flag in the found monitoring information. When there is no monitoring information, the tracking for the second file may be terminated because it is not suspicious behavior. After setting the first flag, the electronic device 100 may confirm whether the second flag is already set in the monitoring information. When the second flag is already set in the monitoring information, the electronic device 100 may detect at least some of the related processes that have performed the file open, the file generation, and the file deletion related to the corresponding document file as the suspicious behavior. The subsequent process may be the same as described above.

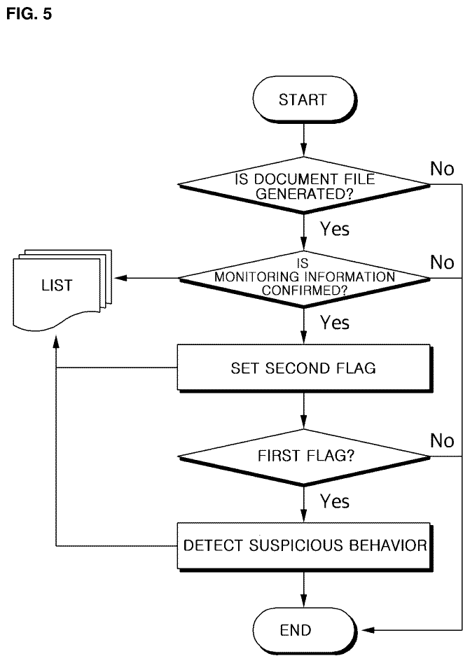

FIG. 5 is a flowchart for monitoring deletion of the document file according to one embodiment.

Referring to FIG. 5, a flowchart of the document file generation monitoring process may be confirmed. That is, when the document file such as the second file is deleted, the electronic device 100 may detect this in the kernel stage and generate the corresponding monitoring information in the list, through the document file deletion monitoring process. In other words, it is possible to confirm whether the first file has been previously opened and the monitoring information has been generated, find the monitoring information, and set the second flag in the found monitoring information. When there is no monitoring information, the tracking for the first file may be terminated because it is not suspicious behavior. After setting the second flag, the electronic device 100 may confirm whether the first flag is already set in the monitoring information. When the first flag is already set in the monitoring information, the electronic device 100 may detect at least some of the related processes that have performed the file open, the file generation, and the file deletion related to the corresponding document file as the suspicious behavior. The subsequent process may be the same as described above.

As described above, by allowing each of the three independent monitoring processes related to the behavior information to manage the list in real time, it is possible to more easily perform the ransomware detection method of the present disclosure. However, the ransomware detection method of the present disclosure does not necessarily have to be performed by the three independent monitoring processes, and the cases where the above-described ransomware detection method is performed according to a single process or various methods are also included in the scope of the present disclosure.

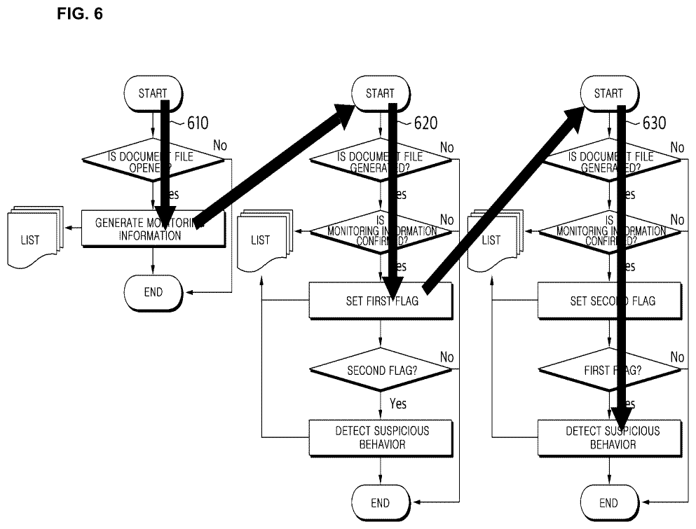

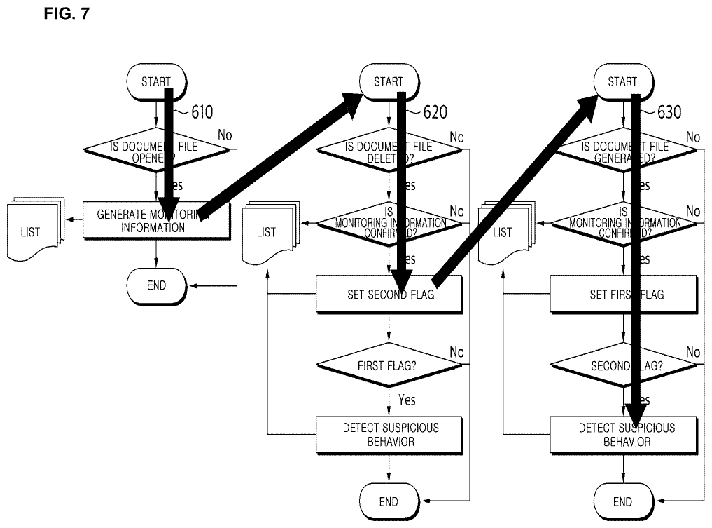

In the case of performing the ransomware detection method of the present disclosure by the three independent monitoring processes as described in FIGS. 3 to 5, when the file is stored and then deleted and the file is deleted and then stored, how steps S210 to S240 of FIG. 2 described above are linked to each monitoring process will be described with reference to FIGS. 6 and 7.

FIG. 6 is a flowchart in which ransomware is detected when a file is stored and then deleted, according to an embodiment.

Referring to FIG. 6, first, the monitoring information generation in step S210 may be performed by a document file open monitoring process 610. Thereafter, setting the first flag in step S220 may be performed by a document file generation monitoring process 620. Since FIG. 6 corresponds to the case where the document file is stored and then deleted, it is not detected as the ransomware by the document file generation monitoring process 620. Next, setting the second flag and detecting the suspicious behavior in step S230 may be accomplished by a document file deletion monitoring process 630. As described above, it is possible to detect the ransomware with a pattern in which the document file is stored and then deleted. Step S240 and subsequent steps are omitted in this drawing.

FIG. 7 is a flowchart in which the ransomware is detected when the file is deleted and then stored, according to an embodiment.

Referring to FIG. 7, first, the monitoring information generation in step S210 may be performed by a document file open monitoring process 710. Thereafter, setting the first flag in step S220 may be performed by a document file deletion monitoring process 720. Since FIG. 7 corresponds to the case where the document file is deleted and then stored, it is not detected as the ransomware by the document file generation monitoring process 720. Next, setting the first flag and detecting the suspicious behavior in step S230 may be accomplished by a document file generation monitoring process 730. As described above, it is possible to detect the ransomware with a pattern in which the document file is deleted and then generated. Step S240 and subsequent steps are omitted in this drawing.

As illustrated in FIG. 7, in the case where the document file is deleted and then generated, it may be detected using the conventional technique that determines whether or not it is encrypted by comparing the headers of the existing file and the newly stored file, and may be detected only by the method according to the present disclosure. In addition, the ransomware detection method of the present disclosure can prevent not only the generation pattern after the deletion of such document files, but also the deletion after the generation or the bypassing by calling the system process. In other words, when there is the pattern in which the file generation and file deletion are performed regardless of the order after opening the file, the ransomware detection method of the present disclosure has the advantage of being able to detect and block any ransomware in real time based on the behavior information in any way.

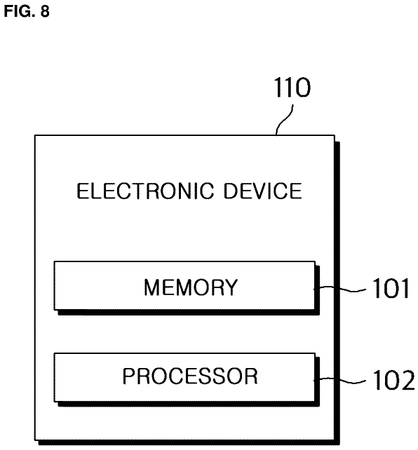

FIG. 8 is a block diagram of an electronic device according to one embodiment.

An electronic apparatus 100 may include a memory 101 and a processor 102 according to an embodiment. Only components related to the present embodiments are illustrated in the electronic device 100 illustrated in FIG. 8. Accordingly, it can be understood by those of ordinary skill in the art related to the present embodiment that other general-purpose components may be further included in addition to the components illustrated in FIG. 8. In one embodiment, the processor 102 may be included in a controller.

The processor 102 may control the overall operation of the electronic device 100 and process data and signals. The processor 102 may be configured in at least one hardware unit. Further, the processor 102 may be operated by one or more software modules generated by executing program codes stored in the memory 101. The processor 102 may include a memory, and the processor 102 may control the overall operation of the electronic apparatus 100 and process the data and signals by executing program codes stored in the memory.

The processor 102 may be set to generate monitoring information including information on a first file in response to an open of a first file, set any one of a first flag corresponding to file deletion and a second flag corresponding to file generation in the monitoring information in response to first behavior associated with the first file, set a flag different from the flag set in the monitoring information in response to the first behavior among the first and second flags in the monitoring information in response to a second behavior that is a subsequent behavior of the first behavior, and detect a process associated with the ransomware by performing analysis based on the first and second flags set in the monitoring information.

According to the embodiment, the electronic device 100 may additionally include a transceiver for performing wired/wireless communication. The electronic device 100 may communicate with an external electronic device using a transceiver. An external electronic device may be a terminal or a server. In addition, communication technologies used by the transceiver may include global system for mobile communication (GSM), code division multi access (CDMA), long term evolution (LTE), 5G, wireless LAN (WLAN), and wireless-fidelity (Wi-Fi), Bluetooth™, radio frequency identification (RFID), infrared data association (IrDA), ZigBee, near field communication (NFC), and the like.

The apparatus according to the above-described embodiments may include a processor, a memory that stores and executes program data, permanent storage such as a disk drive, a communication port that communicates with an external device, a touch panel, a key, a user interface device such as a button, and the like. Methods implemented as software modules or algorithms may be stored on a computer-readable recording medium as computer-readable codes or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a CD-ROM or a digital versatile disc (DVD)), and the like. The computer-readable recording medium may be distributed in computer systems connected to each other through a network, and as a result, the computer-readable codes may be stored in a distributed scheme and executed. The medium may be readable by a computer, stored in a memory, and executed on a processor.

The present embodiments may be represented by functional block configurations and various processing steps. These functional blocks may be implemented by various numbers of hardware and/or software components that execute specific functions. For example, the embodiment may employ integrated circuit configurations, such as memory, processing, logic, and a look-up table, capable of executing various functions by control of one or more microprocessors or other control devices. Similar to executing the components in software programming or software elements, and the present embodiment can be implemented in programming or scripting languages such as python, C, C++, Java, and assembler, including various algorithms implemented by a combination of data structures, processes, routines or other programming configurations. Functional aspects may be implemented in algorithms executed on one or more processors. In addition, the present embodiment may employ a conventional technology for electronic environment setting, signal processing, and/or data processing, and the like. Terms such as “mechanism,” “element,” “means,” and “configuration” may be used widely, and are not limited to mechanical and physical configurations. The terms may include the meaning of a series of routines of software in connection with a processor or the like.

The above-described embodiments are merely examples, and other embodiments may be implemented within the scope of the following claims.

What is claimed is:

1. A ransomware detection method of an electronic device, comprising:
generating monitoring information including information on a first file in response to an open of a first file;
setting any one of a first flag corresponding to file generation and a second flag corresponding to file deletion in the monitoring information in response to a first behavior associated with the first file;
setting a flag different from the flag set in the monitoring information in response to the first behavior among the first and second flags in the monitoring information in response to a second behavior that is a subsequent behavior of the first behavior; and
detecting a process associated with the ransomware by performing analysis based on the first and second flags set in the monitoring information.

2. The ransomware detection method of claim 1, wherein the generating of the monitoring information including the information on the first file includes storing the monitoring information including the information on the first file in a list associated with an open of a document file including the first file,
the setting of the flag different from the flag set in response to the first behavior among the first or second flag in the monitoring information includes:
detecting the second behavior as the subsequent behavior of the first behavior, associated with the first file;
confirming the monitoring information corresponding to the first file in the list; and
setting the flag different from the flag set in the monitoring information in response to the first behavior among the first and second flags in the monitoring information in response to the second behavior, and
the detecting of the process associated with the ransomware includes detecting at least some of the at least one first process, which opens the first file and performs the first and second behaviors, as a process associated with the ransomware by confirming that the first flag and the second flag are set in the monitoring information.

3. The ransomware detection method of claim 2, wherein the detecting of the at least some of the at least one process as the process associated with the ransomware includes:
analyzing a call structure of the first process that opens the first file and performs the first and second behaviors based on a process call tree;
detecting a second process that calls at least some of the first process based on the call structure; and
further detecting at least some of the second process as the process associated with the ransomware.

4. The ransomware detection method of claim 3, wherein the further detecting of the at least some of the second process as the process associated with the ransomware includes classifying at least some of the first and second processes into a system process and a suspicious process, and detecting at least some of the suspicious processes as the process associated with the ransomware.

5. The ransomware detection method of claim 4, wherein the system process includes at least a portion of a scheduler and a shell.

6. The ransomware detection method of claim 2, wherein the open of the first file of the first process and the first and second behaviors are detected by analyzing the call to the corresponding command at a kernel stage, and the monitoring information further includes information on the first file confirmed by analyzing the call.

7. The ransomware detection method of claim 6, further comprising:
blocking, at the kernel stage, the command called from the kernel level by at least some of the first processes.

8. The ransomware detection method of claim 2, wherein the first process includes a 1-1th process associated with the open of the first file, a 1-2th process associated with the first behavior, and a 1-3th process associated with the second behavior, at least some of which are different from each other.

9. The ransomware detection method of claim 1, wherein the first behavior corresponds to the file generation of a second file associated with the first file, the second behavior corresponds to the file deletion of the first file, and the first flag is set in monitoring information in response to the first behavior.

10. The ransomware detection method of claim 9, further comprising:
performing the file deletion of the first file according to the second behavior and the deletion of the second file generated according to the first behavior.

11. The ransomware detection method of claim 1, wherein the first behavior corresponds to the file deletion of the first file, the second behavior corresponds to the file generation of the second file associated with the first file, the second flag is set in the monitoring information in response to the first behavior, and the monitoring information and backup information corresponding to the first file are stored in association with each other.

12. The ransomware detection method of claim 11, further comprising:
restoring the first file deleted according to the first behavior based on the backup information and deleting the second file generated according to the second behavior.

13. The ransomware detection method of claim 1, wherein the second file generated by any one of the first and second behaviors corresponding to the file storage is confirmed as at least one of a file generated in a directory corresponding to the first file or a file generated with a similarity to the first file greater than or equal to a threshold value.

14. The ransomware detection method of claim 1, wherein the detecting of the process associated with the ransomware includes performing the analysis of the process further based on information on a time difference between the first and second behaviors detected.

15. The ransomware detection method of claim 1, wherein the detecting of the process associated with the ransomware includes performing the analysis of the process further based on information on the number of times per hour that the a combination of the first and second behaviors associated with each file included in a specific range of directories including the first file is detected.

16. A computer-readable non-transitory recording medium in which a program for a computer to execute the method of claim 1 is recorded.

17. An electronic device for detecting ransomware, comprising:
a memory that stores an instruction; and
a processor connected to the memory and set to generate monitoring information including information on a first file in response to an open of a first file, set any one of a first flag corresponding to file deletion and a second flag corresponding to file generation in the monitoring information in response to first behavior associated with the first file, set a flag different from the flag set in the monitoring information in response to the first behavior among the first and second flags in the monitoring information in response to a second behavior that is a subsequent behavior of the first behavior, and detect a process associated with the ransomware by performing analysis based on the first and second flags set in the monitoring information.
